(19) United States
(12) Patent Application Publication
(10) Pub. No.: US 2006/0159523 A1
(43) Pub. Date: Jul. 20, 2006

(54) Underwater enclosure apparatus and method for constructing the same

(75) Inventors: Mark Dixon, Wimbledon (GB); Dan Jackson, Bletchingly (GB)

Correspondence Address: CONLEY ROSE, P.C., PO BOX 3267, HOUSTON, TX, 77253-3267, US

(73) Assignee: Cooper Cameron Corporation, Houston, TX (US)

(21) Appl. No.: 10/528,719

(22) PCT Filed: Sep. 26, 2003
(86) PCT No.: PCT/GB03/04191

§ 371 Date: Feb. 14, 2006

(30) Foreign Application Priority Data
Sep. 28, 2002 (GB) 0222579.5

(51) Int. Cl. F16L 1/00; F16L 1/12

(52) U.S. Cl. 405/162; 405/158

(57) ABSTRACT

Apparatus for providing an enclosure, for example as a housing or to provide buoyancy, at underwater locations is disclosed comprising an inner shell and an outer shell, with a structural filler disposed between the two. The shells are prepared from fibre-reinforced plastic, with the fibres being oriented to provide resistance to both longitudinal and radial stresses induced in the apparatus by the hydrostatic pressure. The filler may be a structural filler comprising structural members extending between the inner and outer shells and occupying less than 60% of the volume of the cavity between the two shells. Alternatively, the filler may be a substantially void-free structural filler, such as a polyester resin. Methods of fabricating the apparatus are disclosed. In addition, a method of deballasting a buoyancy module is disclosed, in which the ballast, for example water, is withdrawn from the module by means of reduced pressure. Apparatus for deballasting is also disclosed.

### TECHNICAL FIELD OF THE INVENTION

The present invention relates to an enclosure apparatus, especially for providing buoyancy to underwater installations, and to a method for constructing the same. The apparatus finds use in a range of underwater applications, in particular for providing buoyancy to underwater structures and installations employed in the exploration and production of oil and gas. The apparatus may also be used at underwater locations to house equipment sensitive to hydrostatic pressure or intolerant of an underwater environment.

### BACKGROUND OF THE INVENTION

Many underwater operations require the use of devices to provide buoyancy to subsurface structures and installations, as well as to vehicles used underwater. The exploration and production of oil and gas at subsea requires the use of buoyancy in many of its underwater operations. For example, risers extending between a vessel or deck at the surface of the sea or ocean to the wellhead on the sea or ocean floor are frequently required to be provided with buoyancy. Remotely operated vehicles (ROV's) require buoyancy devices to be incorporated into their design and construction. Still further applications for underwater buoyancy include suspended moorings, in which mooring lines and chains are held out of contact with critical subsurface equipment, such as pipelines and wellheads, and subsurface markers for prelaid structures and installations. Devices for providing buoyancy are known in the art and are commercially available, for example a range of modular buoys available from the Balmoral Group.

A variety of materials are known for use as the buoyancy providing medium in the aforementioned buoyancy devices. Polyurethane foam, having closed cells, is used to prepare buoys for light load applications in surface or shallow water uses. Copolymer polyvinyl chloride foam is also employed as the buoyancy medium in such devices as buoys. A third class of material used as the buoyancy providing medium is syntactic foam. Syntactic foam has found the most widespread commercial use as the buoyancy providing medium in buoyancy devices, in particular in deep water applications.

Syntactic foam is a term used to refer to a range of foam materials, all of which comprise a polymer resin loaded with hollow microspheres. The microspheres serve to reduce the overall density of the polymer resin and provide the necessary buoyancy of the foam material. The properties of the syntactic foam may be modified by varying the composition of the polymer resin and by varying the size and number of microspheres incorporated into the resin material.

Syntactic foam has been known for many years and employed as a material for providing buoyancy in a range of underwater applications. Syntactic foam installations for use in the buoyancy modules of subsea risers have been known since 1968. One significant disadvantage of syntactic foam is that the material, while having a low density and thus a high buoyancy, lacks inherent strength and robustness. Thus, U.S. Pat. No. 4,021,589 discloses a layered skin useful for protecting buoyancy materials of the type comprising a plurality of generally spherical buoyant bodies encased in a matrix of syntactic foam. The skin comprises an inner layer of syntactic foam and an outer layer capable of resisting damage to the structure and providing strength. The outer layer is typically a reinforcing material, such as fiberglass permeated by syntactic foam. The outer, reinforced layer is required in order to provide the overall unit with the necessary resistance to damage caused by the normal operations for handling, installing and deploying the buoyancy unit.

While widely used, syntactic foam buoyancy devices suffer a number of significant drawbacks. First, as noted above, the syntactic foam itself is inherently weak and easily damaged. The need to provide the foam with some form of reinforced coating or covering increases the complexity of the method of manufacturing the buoyancy device, the overall time of manufacture and the overall cost of the device. Further, syntactic foam has limits as to its application. The foam is generally cast into the shape in which it will be finally employed, such as a buoy or a riser floatation unit. The casting process is limited in terms of the overall size of the foam unit and it is not possible to easily cast the larger units required in certain underwater operations. This again adds to the complexity, time and cost of constructing and installing the syntactic foam buoyancy device.

Perhaps more importantly, the complexity and cost of deploying syntactic foam at depth increases dramatically as the depth of the installation increases. In order to provide the syntactic foam with the necessary rigidity to withstand the very high hydrostatic pressures at depth, the density of the foam must be increased. An increase in foam density is achieved by increasing the relative proportion of polymer resin in the foam and reducing the relative proportion of microspheres. This in turn decreases the buoyancy of the foam material. Thus, for a given degree of buoyancy, the volume of syntactic foam required increases rapidly as the intended depth of application increases. The limit of deployment of syntactic foam structures varies according to how the foam is installed. For example, the practical limit for an arch structure is to a depth in the region of about 400 meters (about 1200 feet). Distributed foam buoys may be made to do as deep as 2500 meters. However, the cost of such buoys is largely prohibitive on a commercial scale. In general, there is a perception in the art that syntactic foam, while capable of being deployed at great depths, has a practical limit on its depth of deployment of about 1000 meters (about 3500 feet). There is therefore a need in the art for a buoyancy device which is capable of being constructed to any size desired and is capable of being deployed at significant depths, without increased complexity and costs.

U.S. Pat. No. 3,598,275 discloses a design of radial-filament cylinder for use in deep submergence applications, for example for use as buoyant elements for attachment to underwater vehicles. U.S. Pat. No. 3,598,275 discloses that metal shell constructions are well known to provide buoyancy devices with sufficient strength to resist the high compressive forces encountered underwater at depth. However, such metal constructions are limited by their high weight to displacement ratios, as the thickness of metal required renders the device impractical. In such cases, supplementary buoyancy means are required. U.S. Pat. No. 3,598,275 proposes to solve this problem by providing a cylindrical vessel having a shell composed of filament-reinforced resin, in which all the individual filaments lengths are oriented substantially normally to the surface of the shell. The wall of the vessel can be in the form of a single shell reinforced by a suitable arrangement of internal stiffening rings or in the form of a sandwich construction composed of a low density core confined between two such shells in concentric relationship. The core material is primarily a low strength resin and serves to transmit stress from the outer shell to the inner shell. Preferred core materials indicated in U.S. Pat. No. 3,598,275 are syntactic foams or other resin matrices and fillers. Alternatively, U.S. Pat. No. 3,598,275 suggests forming the core in the cylindrical portion of the construction from a series of resin rings, spaced apart so as to leave a series of circumferential holes. In a further alternative, a series of resin rings are employed, which abut one another, with each ring being formed with a semicircular recess on each side. In these arrangements, the core material between the inner and outer shells of the domed ends is again syntactic foam.

The proposals of U.S. Pat. No. 3,598,275 have not achieved widespread acceptance in the art and currently the vast majority of buoyancy devices employed on a commercial scale still rely on the traditional syntactic foam technology, with its attendant problems and drawbacks as discussed above. Accordingly, there is a need for an improved buoyancy apparatus, that avoids the shortcomings of the established syntactic foam-based technology.

### SUMMARY OF THE INVENTION

According to a first aspect, the present invention provides an apparatus for providing an enclosure in locations of elevated pressure, the apparatus comprising:

an inner housing comprising an inner housing body and two opposing inner housing ends;

an outer housing comprising an outer housing body and two opposing outer housing ends;

the inner housing being disposed fully within the outer housing, the inner and outer housings defining an annular cavity therebetween; and

a structural filler within the cavity extending between the outer housing and the inner housing, the structural filler comprising a plurality of spaced apart structural members for transferring stress between spaced apart regions of the inner surface of the outer housing to corresponding spaced apart regions of the outer surface of the inner housing, the structural members occupying less than 60% of the volume of the cavity occupied by the structural filler.

The apparatus according to the first aspect of the invention represents an improved means of providing buoyancy, capable of operation at depths greater than those feasible or economic for known devices, such as syntactic foam-based buoyancy units. The arrangement of concentric shells, combined with a low density structural filler extending between the two shells allows the very high stresses applied by the hydrostatic pressure at depth to be dissipated effectively within a very pressure-resistant structure. By ensuring that the volume of the cavity occupied by the structural members is less than 60%, the apparatus combines both high strength and high buoyancy.

The structural members preferably occupy less than 50% of the volume of the cavity occupied by the structural filler, more preferably less than 40%, with less than 35% being especially preferred.

Each structural member may extend circumferentially in a plane perpendicular to the longitudinal axis of the apparatus within the cavity, or may extend at an acute angle to the longitudinal axis. In a preferred embodiment, the structural members are preferably combined in the form of a honeycomb. Such a honeycomb may be a metal honeycomb, such as aluminium or light alloy. Alternatively, the honeycomb may be of a polymer material, such as nylon. In one preferred embodiment, the cavities of the honeycomb are filled with a foam, which serves to increase the shear strength of the honeycomb structure.

Alternative forms of the structural members include both I-beam configurations and tubes. Tubular structural members are preferably circular in cross-section, although other forms are also possible, such as members having a channel or box cross-section. The tubes may extend circumferentially around or at an acute angle to the longitudinal axis. In the latter case, the structural members may comprise one or more tubes extending helically within the cavity. One advantage of employing a tubular structural member is the ability to fill the tube with a pressurized fluid, such as a gas, for example nitrogen or air. The effect of the pressurized fluid is to pre-stress the tube, increasing its capacity to withstand and bear external pressures and stresses arising from hydrostatic forces. This in turn helps to allow the apparatus to be deployed at increased depths.

In a further aspect, the present invention provides an apparatus as hereinbefore described, in which the filler is an expandable epoxy foam. The expandable epoxy foam is a structural filler, the components of which are applied to the annular cavity, for example by pouring or injection. Once applied, the foam expands in situ to fill the cavity and provide a structural bridge between the inner shell and the outer shell. Expandable epoxy foam exhibits higher strength, higher resistance to shear and an increased density, compared with conventionally applied foams. Expandable foam does not require a blowing agent to create the foam structure, unlike other foam materials. The expandable foam bonds to the surfaces of the inner and outer shells, obviating the need for an adhesive.

According to a further aspect of the present invention, there is provided an apparatus for providing an enclosure in locations of elevated pressure, the apparatus comprising:

an inner housing comprising an inner housing body and two opposing inner housing ends;

an outer housing comprising an outer housing body and two opposing outer housing ends;

the inner housing being disposed fully within the outer housing, the inner and outer housings defining an annular cavity therebetween; and

a structural filler within the cavity extending between the outer housing and the inner housing, the structural filler comprising a continuous, substantially void-free resinous phase.

The use of a continuous, substantially void-free resinous phase as a structural filler allows a very strong, pressure-resistant apparatus to be provided. While the density of the filler is higher than of the fillers discussed above, the continuous, void-free phase provides virtually a complete transfer of stress from the outer shell to the inner shell, thus sharing the stresses induced by hydrostatic pressure.

The filler is preferably a resin, especially a polyester resin, although other suitable resins may be employed, such as epoxy resin. The resin preferably comprises a solid filler, such as finely powdered chalk. The presence of a solid filler allows the peak curing temperature of the resin to be reduced, thus protecting the inner and outer shells from excessive temperatures during the curing of the resinous filler. The structural filler preferably comprises a solid filler in an amount of from 10 to 90% by weight, more preferably from 20 to 60% by weight.

According to a further aspect, the present invention provides an apparatus for providing an enclosure in locations of elevated pressure, the apparatus comprising:

an inner housing comprising an inner housing body and two opposing inner housing ends;

an outer housing comprising an outer housing body and two opposing outer housing ends;

the inner housing being disposed fully within the outer housing, the inner and outer housings defining an annular cavity therebetween; and

a structural filler within the cavity extending between the outer housing and the inner housing;

at least one of the inner housing or the outer housing being formed from a fibre-reinforced matrix comprising a plurality of fibres extending helically with respect to the longitudinal axis of the apparatus, each fibre extending at an angle of from 15° to 85° to the longitudinal axis of the apparatus.

In the buoyancy units of the prior art, in particular U.S. Pat. No. 3,598,275, fibres were used to reinforce the shells. However, the fibres were arranged to extend radially with respect to the longitudinal axis of the apparatus. Tests have shown that such an arrangement does not provide adequate resistance to the stresses induced in the apparatus as a result of hydrostatic pressure. A generally cylindrical apparatus, such as would typically be employed, having either flat or domed ends, is subject to stresses in several directions. First, as would be expected, hydrostatic pressure acts on the outer surface in a radially inwards direction, tending to crush or flatten the structure. However, the same hydrostatic pressure acts on the ends of the apparatus in a generally longitudinal direction, tending to shorten or “concertina” the structure. The radially extending fibres of the prior art may well resist the radially inwards acting forces. However, the radially extending fibres have been found to offer little to no resistance to the very significant longitudinal end forces generated at depths.

The fibres typically extend helically along the apparatus, preferably extending at an angle of from 35° to 65° to the longitudinal axis, more preferably from 45° to 60°. In a particularly preferred embodiment, the said housing comprises a plurality of layers of fibre-reinforced matrix, the fibres in adjacent layers extending in opposing directions. This may be represented by considering the fibre or fibres in one layer to extend at an angle of x° to the longitudinal axis and the fibre or fibres in an adjacent layer to extend at an angle of 360-x° to the longitudinal axis. The angle x is preferably in the range of from 45° to 65°, more preferably from 50° to 60°. In an optimum arrangement of strength and ease of manufacture, the fibres in adjacent layers extend at about + and −55° to the longitudinal axis.

Preferably both the inner and the outer housing comprise a fibre-reinforced matrix as hereinbefore described.

The continuous phase in the fibre-reinforced matrix is preferably a resin, for example a polyester resin or epoxy resin. The fibres may be glass fibres, carbon fibres or nylon fibres.

In all embodiments of the apparatus of the present invention, a protective layer may be provided to extend over the outer surface of the outer housing. The protective layer serves to prevent the housings from being damaged during transport and deployment. The protective layer preferably comprises a shock absorbent layer, such as a foam, for example a syntactic foam, or a honeycomb material. The protective layer preferably comprises a rigid outer layer, for example a layer of fibre-reinforced plastic or metal, such as steel or aluminium. If an outer layer of metal is employed, it is convenient to have the metal in the form of a strip, preferably extending helically around the outer surface of the apparatus.

The apparatus may comprise just two housings, an inner housing and an outer housing. It will however be appreciated that a third and further housing may be provided, each further housing defining a cavity with the adjacent housing. Structural fillers may be provided within such cavities as herein described.

In one embodiment, the apparatus comprises one or more bulkheads disposed within the interior of the inner housing, serving to divide the interior into two or more compartments. The inner housing may be formed from two housing portions, connected by a joint. If this form of construction is employed, a bulkhead is preferably disposed to coincide with the joint in the inner housing. In addition, or alternatively, a bulkhead may be disposed at the junction of one or both inner housing ends and the inner housing body. The bulkhead is preferably arranged such that, in the event of a leak at the junction, water is caused to enter the interior of the inner housing end. A preferred form of bulkhead is a compliant bulkhead, with a stiffness such that differential stiffness between the bulkhead and the inner housing is kept a minimum. Compliancy in the bulkhead may be provided by varying the thickness of the bulkhead, or by providing the bulkhead with appropriately sized apertures.

The apparatus provided by the various aspects of the present invention finds use in providing buoyancy to underwater installations and structures, such as arches, risers, pipelines, cables, control lines and the like. As noted, the apparatus is particularly advantageous when used in such applications. In addition, the apparatus of the various aspects of the present invention may be used to house equipment at underwater locations, thus protecting the equipment from the underwater environment. The apparatus is particularly useful for housing equipment sensitive to hydrostatic pressure or to exposure to water. It will be understood that the apparatus can perform both the functions of providing buoyancy and housing simultaneously. In a further aspect, the present invention provides methods of preparing an apparatus for providing an enclosure in locations of elevated pressure, such as that described above. In a first embodiment, a method is provided comprising:

forming an inner shell;

applying a filler to the outer surface of the inner shell; and

forming an outer shell around the outer surface of the core material.

The inner shell may be formed from any suitable material and by any suitable method. A preferred embodiment has the inner shell formed from fibre-reinforced material, such as a polymer, with filaments being wound onto a mandrel. The inner shell may be formed by winding filaments in successive layers, with the filaments being wound at the same or different angles and orientations in adjacent layers. In many cases, it will be necessary to cure the materials forming the inner shell.

The filler is applied to the outer surface of the inner shell. If necessary, the filler may be bonded to the outer surface, for example by means of a suitable adhesive. The adhesive, if used, may be cured if necessary. The filler may be applied as a single layer or, more preferably in larger units, as a series of discrete layers. The filler may be a structural space frame geometric filler, such as a honeycomb, corrugated filler material, channels, beams, such as I-beams, or tubular constructions. Alternatively, the filler may be a sheet polymer or natural filler material, such as balsa wood. A further embodiment employs foam filler. If a foam filler is used, this may be applied to the outer surface of the inner shell as one or more liquid components and allowed to expand upon the surface. The filler may be cured if necessary.

Should an adhesive or filler be employed that requires curing at elevated temperatures, the outer surface of the inner shell may advantageously be protected by a heat retardant material, applied in sufficient thickness and amount to prevent damage to the inner shell at the peak curing temperature. Suitable heat retardant materials include ceramic paper or tape, which may be applied in strips or sheets to the outer surface of the inner shell. Alternatively, the heat retardant material may be applied by means of spraying.

The inner shell may be a complete, enclosed shell. Alternatively, the inner shell may comprise an inner housing body or a portion of an inner housing body. The inner housing body or portion thereof may have an inner housing end attached thereto. In such an arrangement, two or more inner shells are required in order to provide a complete enclosed shell, such as is required in the apparatus as hereinbefore described.

The outer shell may be formed by any suitable means, but is preferably formed by winding filaments onto the outer surface of the filler, to form a fibre-reinforced construction. Preferably, the outer shell is formed by successively winding a plurality of separate layers of filaments. The outer shell may be cured after completion, if necessary.

In a further embodiment, a method of preparing an apparatus for providing an enclosure in locations of elevated pressure is provided, which method comprises:

forming an inner shell;

forming an outer shell;

locating the inner shell concentrically within the outer shell, thereby defining a cavity between the inner and outer shells; and

filling the cavity with a filler.

The inner and outer shells may be formed from any suitable material and by any suitable method, which may be the same or different. A preferred embodiment has one or both of the inner and outer shell formed from fibre-reinforced material, such as a polymer, with filaments being wound onto a mandrel. The said shell or shells may be formed by winding filaments in successive layers, with the filaments being wound at the same or different angles and orientations in adjacent layers. In many cases, it will be necessary to cure the materials forming the shell or shells formed in this way.

The filler may be formed from any of the materials mentioned hereinbefore. However, for ease of construction, it is preferred to employ a filler that is a substantially void-free material or foamed material. If a foamed material is employed, the material may be introduced into the cavity as one or more liquid components and allowed to foam and expand to fill the cavity. Suitable materials for use as the filler in this preferred embodiment include polymers and foamed metals.

In many cases, the filler will require curing after it has been introduced into the cavity. In such cases, it may be problematic to remove the heat generated by the filler material while it cures or sets. This will cause the temperature of the filler and the inner and outer shells to increase. To protect the inner and/or outer shell from excessive temperatures during this stage in the method, a heat retardant material may be applied to one or both of the inner surface of the outer shell or the outer surface of the inner shell. The heat retardant material should be applied in sufficient thickness and amount to protect the respective shell from damage at the peak curing temperature of the filler. Suitable heat retardant materials are as disclosed hereinbefore.

One or both of the inner shell or outer shell may comprise a housing body or a portion of a housing body. The housing body or portion thereof may have a housing end attached thereto. In such an arrangement, two or more shell portions are required in order to provide a complete enclosed shell, such as is required in the apparatus as hereinbefore described.

A further aspect of the present invention provides a third method for preparing an apparatus for providing an enclosure in locations of elevated pressure, the method comprising:

forming an inner shell;

applying a filler to the outer surface of the inner shell;

forming an outer shell;

heating the outer shell to cause expansion of the outer shell

locating the inner shell and the applied filler concentrically within the outer shell; and

allowing the outer shell to cool so as to mechanically engage the filler in an interference fit.

The inner and outer shells may be formed from any suitable material and by any suitable method, which may be the same or different. A preferred embodiment has the inner shell formed from fibre-reinforced material, such as a polymer, with filaments being wound onto a mandrel. The shell may be formed by winding filaments in successive layers, with the filaments being wound at the same or different angles and orientations in adjacent layers. In many cases, it will be necessary to cure the materials forming the shell formed in this way.

The outer shell is formed from any suitable material that exhibits sufficient expansion upon heating so as to provide the necessary engagement with the inner shell, upon cooling. Metal outer shells are particularly suitable, with steel or aluminium being preferred materials of construction for the outer shell.

One or both of the inner shell or outer shell may comprise a housing body or a portion of a housing body. The housing body or portion thereof may have a housing end attached thereto. In such an arrangement, two or more shell portions are required in order to provide a complete, enclosed shell, such as is required in the apparatus as hereinbefore described. In one embodiment, one or both of the inner and outer shells comprises a housing body and a housing end, the method further comprising attaching a second housing end to the or each shell. Alternatively, two such inner and/or outer shells can be attached at their open ends, to form an enclosed shell. In an alternative embodiment, one or both of the inner and outer shells consists of a housing body, to which are attached two housing ends.

The filler is applied to the outer surface of the inner shell. If necessary, the filler may be bonded to the outer surface, for example by means of a suitable adhesive. The adhesive, if used, may be cured if necessary. The filler may be applied as a single layer or, more preferably in larger units, as a series of discrete layers. The filler may be a structural space frame geometric filler, such as a honeycomb, corrugated filler material, channels, beams, such as I-beams, or tubular constructions. Alternatively, the filler may be a sheet polymer or natural filler material, such as balsa wood. A further embodiment employs foam filler. If a foam filler is used, this may be applied to the outer surface of the inner shell as one or more liquid components and allowed to expand upon the surface. The filler may be cured if necessary.

Should an adhesive or filler be employed that requires curing at elevated temperatures, the outer surface of the inner shell may advantageously be protected by a heat retardant material, applied in sufficient thickness and amount to prevent damage to the inner shell at the peak curing temperature. Suitable heat retardant materials include ceramic paper or tape, which may be applied in strips or sheets to the outer surface of the inner shell. Alternatively, the heat retardant material may be applied by means of spraying.

Heat retardant materials may also be applied to the outer surface of the filler, in order to protect the filler from the heated outer shell when first applied and until the outer shell has cooled and contracted onto the filler.

Examples of suitable heat retardant materials include ceramic tapes and polymer-based products, such as melamine.

The filler, once applied to the outer surface of the inner shell may require its outer diameter to be adjusted, in order to correspond to the inner diameter of the outer shell. The outer diameter of the filler should be larger than the inner diameter of the outer shell by an amount sufficient to provide the required interference fit between the filler and the outer shell. This adjustment may be made, for example, by machining the filler once it is in place and has cured.

The outer shell is heated prior to having the inner shell and filler inserted. The effect of the heating is to expand the outer shell, thereby increasing its diameter. The material of construction of the outer shell will determine the temperature to which it should be heated and the expansion to be achieved.

If desired, for additional strength, the outer shell may be bonded to the filler by a suitable adhesive. If required, the adhesive may be cured. A heat retardant layer, such as hereinbefore described, may be applied to the inner surface of the outer housing, in order to protect the outer housing during the curing of the adhesive.

The apparatus can have a protective layer, as hereinbefore described, applied to its outer surface. This is most conveniently applied once the apparatus has been constructed. However, if preferable and if the method of construction allows, the protective layer may be applied to the outer surface of the outer shell, prior to its incorporation with the filler and inner shell.

A further aspect of the present invention concerns a method of deploying a buoyancy apparatus, for example the form of apparatus as hereinbefore described. The known method of deploying a buoyancy apparatus requires that the apparatus has one or more inner cavities filled with a ballast in an appropriate amount to provide the required level of buoyancy. For the deployment, this may be neutral buoyancy or negative buoyancy. The ballast is conventionally water. Once in place, the ballast is forced from the apparatus by the application of pressure, typically using compressed air. To provide this compressed air, a compressor may be employed for deployment at shallow depths. However, it will be appreciated that to force the ballast out of the apparatus requires that the hydrostatic pressure at the deployment depth be overcome. At greater depths, it is impractical to use a compressor and containers of compressed air are retained and employed. It will also be appreciated that the need to provide containers of compressed air at offshore sites on fixed structures or vessels, is both inconvenient and potentially hazardous. An alternative method for deploying buoyancy apparatus is therefore required.

According to this further aspect of the present invention, there is provided a method of deploying a buoyancy apparatus at an underwater location where buoyancy is required, which apparatus has a fluid-tight cavity capable of accommodating a liquid, the method comprising:

ballasting the apparatus by filling the fluid-cavity with a liquid to an extent necessary to provide the appropriate level of buoyancy;

positioning the apparatus at the said location; and

withdrawing the liquid from the fluid-tight cavity.

The ballast liquid is withdrawn by means of reduced pressure or a partial vacuum. This may be provided by means of a reciprocating piston moved within a cylinder. In order to maintain the deballasting apparatus at a practical size, the liquid is preferably withdrawn by repeated operations of the reciprocating piston through a cycle comprising:

movement of the piston in a first direction to draw liquid from the fluid-tight cavity into the cylinder;

movement of the piston in a second direction, opposite the first, to eject liquid from the cylinder to a location other than the fluid-tight cavity.

The ballasting liquid is most conveniently water. This allows the ballast water to be ejected into the environment without environmental damage or harm.

The present invention in a further aspect provides a system for deballasting a buoyancy apparatus, which apparatus has a fluid-tight cavity containing a liquid, the system comprising:

a cylinder;

a piston arranged for reciprocal movement within the cylinder;

a line for connection to the fluid-tight cavity of the apparatus;

a first non-return valve allowing the flow of fluid from the cavity into the cylinder; and

a second non-return valve allowing the flow of fluid from the cylinder.

The cylinder, piston, drive and first and second non return valves may be housed together on a mobile support structure for use in the vicinity of the deployed buoyancy apparatus. The support structure, for example a skid, may be permanently moored adjacent the deployed apparatus. Alternatively, the support structure may be deployed temporarily, to enable deployment of the buoyancy apparatus, after which it may be removed for use elsewhere. The present invention allows the system to be provided in a compact unit, capable of being moved, positioned and operated by a remotely operated vehicle (ROV).

In a preferred embodiment, the piston is operable hydraulically. The system preferably comprises a drive for the piston, such as a hydraulic drive. The hydraulic system may be housed within the support structure, or may be provided by an ROV.

### BRIEF DESCRIPTION OF THE DRAWINGS

Embodiments of the present invention will now be described, by way of example only, having reference to the accompanying figures, in which:

FIG. 1 is a cross-sectional view of an apparatus for providing buoyancy at underwater locations according to one embodiment of the present invention;

FIG. 2 is a cross-sectional view of a portion of the inner and outer housing of a first embodiment of the apparatus of the general design of FIG. 1;

FIG. 3 is a cross-sectional view of a portion of the inner and outer housing of a second embodiment of the apparatus of the general design of FIG. 1;

FIG. 4 is a cross-sectional view of a portion of the inner and outer housing of a third embodiment of the apparatus of the general design of FIG. 1;

FIG. 5 is a cross-sectional view of a portion of the inner and outer housing of a fourth embodiment of the apparatus of the general design of FIG. 1;

FIG. 6a is a cross-sectional view of an apparatus of the general design of FIG. 1 showing a first design of bulkhead within the apparatus;

FIG. 6b is a cross-sectional view of an apparatus of the general design of FIG. 1 showing a second design of bulkhead within the apparatus;

FIG. 7a is a schematic orientation of a portion of a shell of an apparatus to illustrate a first orientation of reinforcing fibres in the shell;

FIG. 7b is a schematic orientation of a portion of a shell of an apparatus to illustrate a second orientation of reinforcing fibres in the shell;

FIG. 8a is a cross-sectional view of a portion of an apparatus of the general design of FIG. 1 having a first embodiment of a protective layer;

FIG. 8b is a cross-sectional view of a portion of an apparatus of the general design of FIG. 1 having a second embodiment of a protective layer;

FIG. 9a is a schematic illustration of an apparatus shell during assembly according to a first embodiment of the method of construction;

FIG. 9b is a schematic illustration of a shell during assembly according to a second embodiment of the method of construction;

FIG. 9c is a cross-sectional view of a portion of a domed housing end of an apparatus of the general design of FIG. 1;

FIG. 10 is a perspective view of an apparatus for deballasting a buoyancy apparatus;

FIG. 11a is a perspective view of an articulated arch for underwater deployment comprising a buoyancy apparatus;

FIG. 11b is a perspective view of a second articulated arch for underwater deployment comprising a buoyancy apparatus;

FIG. 11c is a perspective view of an articulated truss arch for underwater deployment;

FIG. 11d is a perspective view of an arch for underwater deployment comprising buoyancy apparatus;

FIG. 11e is a perspective view of a lay-over arch for underwater deployment; and

FIG. 11f is a perspective view of a tied-in arch.

### DETAILED DESCRIPTION OF THE INVENTION

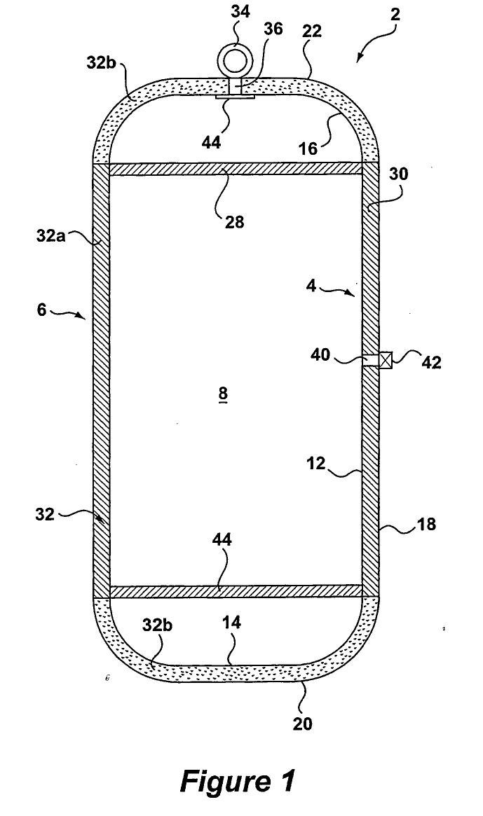

Referring to FIG. 1, one embodiment of an apparatus for providing buoyancy at underwater locations according to the present invention in the form of a buoyancy module is shown and generally represented as 2. The module 2 comprises an inner shell, generally indicated as 4, and an outer shell generally indicated as 6. A buoyancy cavity 8 is formed within the inner shell 4 for receiving ballast as is described hereinafter.

The inner shell 4 comprises a generally cylindrical inner housing 12, closed at each end by an inner housing end 14 and 16. Similarly, the outer shell 6 comprises a generally cylindrical outer housing 18, closed at each end by an outer housing end 20 and 22.

The inner and outer shells 4 and 6 are shown in FIG. 1 as being generally cylindrical. However, it will be understood that other forms that enclose a buoyancy cavity are possible, such as forms having polygonal cross-sections. The ends of both the inner and outer housing are shown in FIG. 1 as being domed. It will be understood that other forms for the ends are also possible. The design of the housing ends will depend upon such factors as the manner of construction and the depth to which the module is being deployed.

The inner shell 4 is arranged concentrically within the outer shell 6, with a cavity 30 being defined therebetween. The cavity 30 contains a filler 32 as hereafter described. The module shown in FIG. 1 is represented as having a first filler 32a in the portion of the cavity defined between the inner and outer housings 12, 18 and a second filler 32b in the portion of the cavity defined between the respective inner and outer housing ends 14, 16 and 20, 22. The first and second fillers 32a and 32b may be the same or may be different.

A ring 34 is secured centrally in one end of the module, by a shank 36 extending through a bore in the outer and inner housing ends 16, 22 and secured to a retaining plate 38 extending across the inner surface of the inner housing end 16 adjacent the bore. The ring provides a means for mooring the module at a desired location. Additional rings may be provided at other positions on the surface of the module 2, as required to securely moor the module.

Fluid access to the buoyancy cavity 8 from the exterior of the module 2 is provided by means of a spigot 40 and a valve 42. Access to the buoyancy cavity 8 in this way may be through the outer and inner shells, or through the housing ends. If access is provided through the outer and inner shells, the access is preferably located adjacent a bulkhead (described hereinafter). This allows ballast fluid to be introduced into and removed from the buoyancy cavity 8, as hereafter described.

Bulkheads 44 extend across the buoyancy cavity 8 within the inner shell 4 in the region of the junction of the inner housing body 12 and each inner housing end 14, 16. The bulkhead 44 may be arranged to divide the buoyancy cavity 8 into several volume portions, with the arrangement shown in FIG. 1 having the volume within each end separated from the main buoyancy cavity. Additional bulkheads may be provided within the inner shell 4, as required.

The inner and outer shells may be formed of any suitable material able to meet the requirements of sufficient strength to withstand the hydrostatic pressure at the depth of deployment and weight. Suitable materials include metals, such as aluminium, alloys and steel. Polymeric materials may also be used, for example polyvinyl chloride and polyesters. Preferably, the material of construction is a fibre-reinforced polymer, such as fibre-reinforced polyester resin. Suitable fibres include carbon fibres and nylon or glass fibres. Resin and fibres suitable for use in the present invention are available commercially (for example T700 carbon fibres ex Toray, L20 epoxy resin ex Bakerlite and TCR composites UF3325).

The fibres may be impregnated with resin shortly before being used in preparing the shells. Alternatively, the fibres may be employed in the form of strips of pre-impregnated fibes (so-called “pre-pregs”), the strips of fibres being employed as herein described.

The inner and outer shells may be formed from the same material or different materials.

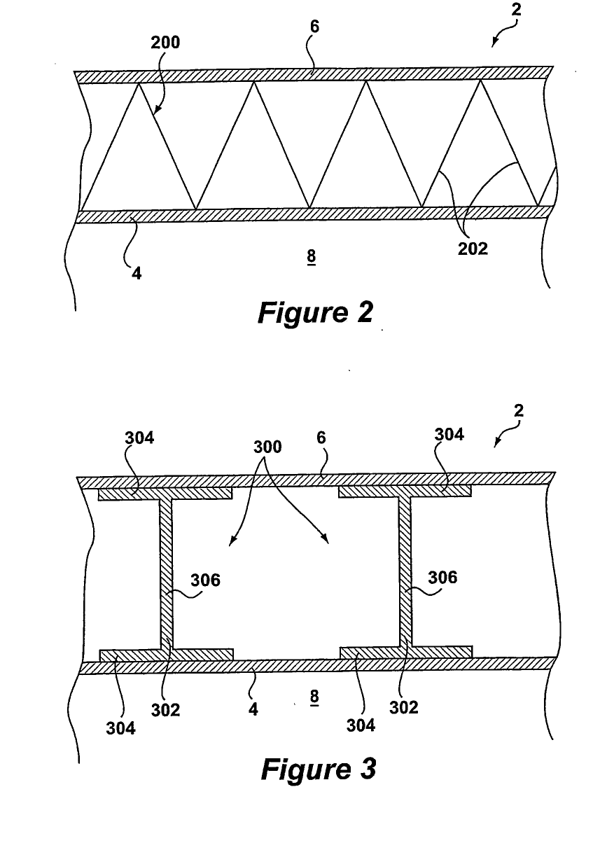

Turning now to FIG. 2, a cross-sectional view of a portion of a buoyancy module 2 is shown, the module having an inner shell 4 and an outer shell 6. The module of FIG. 2 is of the same general design as that shown in FIG. 1. The cavity 30 contains a filler 32. In all embodiments of the present invention, the function of the filler 32 is to transfer and evenly distribute loads and stresses induced in the outer shell 6 by hydrostatic pressure to the inner shell 4. In the embodiment shown in FIG. 2, the filler is a structural space frame geometric filler. This general term is a reference to a filler having spaced apart structural members forming a load transfer bridge between the outer shell and the inner shell. The members are regularly spaced within the cavity in a geometric pattern, in order to provide an even distribution of the load to the inner shell. The structural space frame filler is such that the structural members occupy only a portion of the volume of the cavity, in particular less than 60% of the volume. In a preferred embodiment, the structural members occupy less than 50%, more preferably less than 40% of the volume of the cavity. Preferred fillers have structural members occupying less than 25% of the volume of the cavity, with some fillers occupying less than 15% of the volume of the cavity, while still providing sufficient load transfer between the outer and inner shells. The volume of the cavity 30 not occupied by the structural members of the filler is filled with a gas, such as air, and serves to contribute to the overall buoyancy of the module.

The structural members of the filler may extend circumferentially within the cavity. Alternatively, the structural members of the filler extend at an angle to the longitudinal axis of the module, such as helically around the axis within the cavity.

Turning once again to FIG. 2, the module 2 is shown with a structural space frame filler in the form of a honeycomb 200 having structural members 202 and occupying the cavity 30. Suitable honeycomb fillers are available commercially and include metal and polymer honeycombs. Examples of suitable honeycomb materials are nylon (Nomex™ (for example 48 kg/m³, 0.8 cm (0.3 in) cell size) available ex Hexcel), aluminium honeycomb (ex Hexcel) and polycarbonate honeycomb.

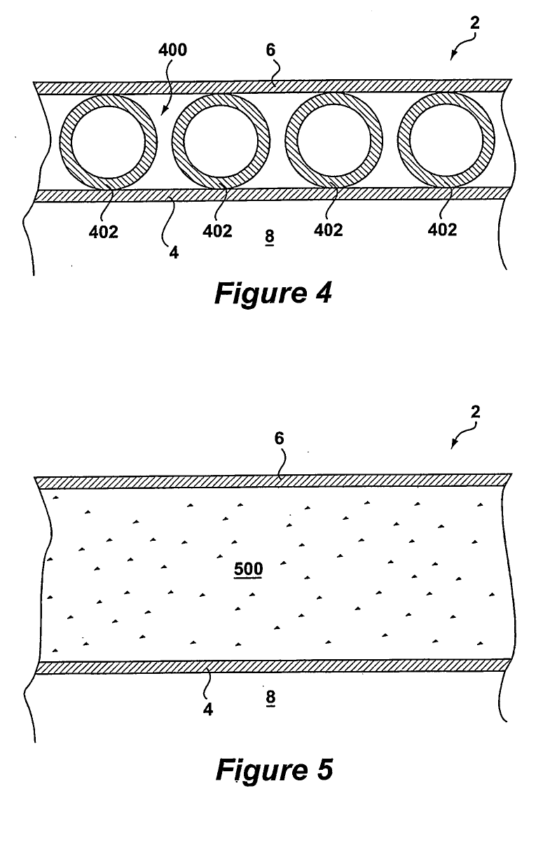

Referring to FIG. 3, a cross-section of a portion of a buoyancy module incorporating an alternative structural space frame filler is shown. The components of the module of FIG. 3 identical to those of FIG. 2 are indicated using the same reference numerals. The filler 300 comprises a plurality of I-beams 302 extending within the cavity. Each I-beam comprises a pair of bracing members 304 each extending parallel to and in contact with one of the inner shell 4 and outer shell 6. A structural member 306 extends between the each pair of bracing members 304 and transfers the load between the inner shell 4 and outer shell 6. The I-beams are spaced apart at a distance sufficient to provide the support and load transfer required at the depth of deployment. Thus, for modules intended for use in shallower depths, the number of beams will be lower and their pitch greater than in modules intended for use at greater depths. In addition, the dimensions of the bracing members 304 and the structural members 306 will vary according to the load to be applied. A single module may have beams 302 of identical dimensions and even distribution within the cavity. Alternatively, beams of different dimensions may be employed and/or in an uneven distribution, depending upon the overall shape of the module and the loads to be accommodated.

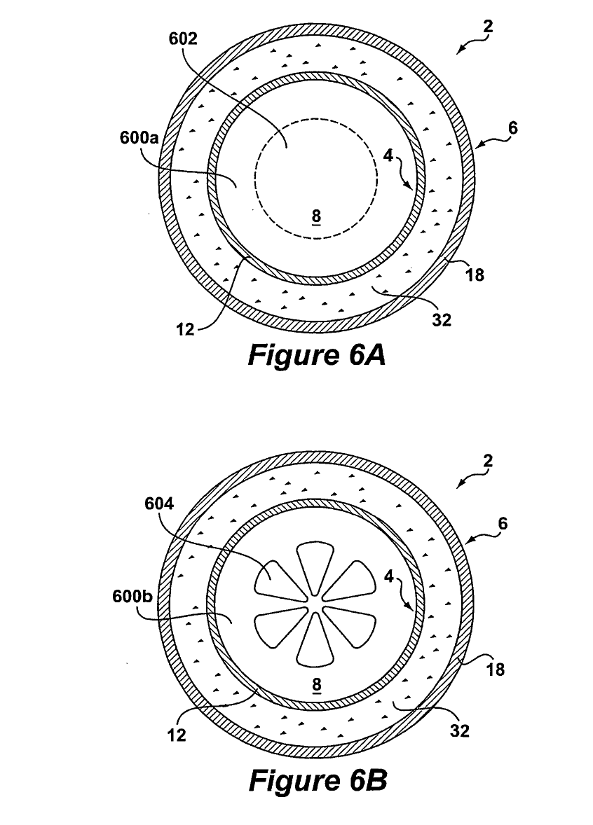

Referring to FIG. 4, a cross-section of a portion of a buoyancy module incorporating a further alternative structural space frame filler is shown. The components of the module of FIG. 4 identical to those of FIG. 2 are indicated using the same reference numerals. The filler 400 comprises a plurality of tubes 402, each tube having an outer diameter corresponding to the distance between the inner shell 4 and the outer shell 6, such that each tube 402 extends between the inner and outer shells 4, 6, providing a structural bridge between the two. The tubes 402 are shown in FIG. 4 with a circular cross-section. However, alternative cross-sectional shapes are also possible.

As shown in FIG. 4, the tubes 402 extend circumferentially within the cavity around the longitudinal axis of the module 2. The tubes 402 may also extend at other angles within the cavity. An alternative arrangement is one in which one or more tubes are arranged helically within the cavity.

The wall thickness of the tubes 402 and their spacing within the cavity is determined by the load to be accommodated, which is in turn determined by the depth of intended deployment of the module.

In one preferred arrangement, the tubes 402 are filled with a fluid under pressure, for example a gas, such as air or nitrogen, or a liquid, such as oil, water or a refined hydrocarbon, such as an alcohol. A tube 402 filled with a pressurized fluid is prestressed with a tensile hoop stress, with the action of the pressurized fluid being to tend the tube to straighten, preloading the module with a force extending radially outwards from the inner shell to the outer shell. Such a stress induced in the module 2 increases the hydrostatic load bearing capacity of the module. The degree of prestress is determined by the pressure of the fluid within the tubes 402. The amount of prestress applied will vary according to the intended depth of deployment, with a greater prestress being advantageous at greater depths. In one arrangement, the tubes 402 are filled with a pressurized fluid and prestressed before deployment. In a second arrangement, the tubes are filled with the pressurized fluid underwater at some depth between the surface and the deployment depth, or are filled at the deployment depth. The filling of the tubes underwater may be accomplished, for example using an ROV with a supply of pressurized fluid.

The fillers 200, 300 and 400 shown in FIGS. 2 to 4 may be used throughout the cavity 30 between the inner and outer housings 4, 6 in the module 2, that is as both fillers 32a and 32b in FIG. 1. Alternatively, as noted above, the aforementioned fillers may be employed only in the portion of the cavity between the inner and outer housing bodies 12, 18, that is as filler 32a in FIG. 1. The filler 32b in the ends of the module 2 may more conveniently be an alternative filler, such as a foam. Suitable foams include commercially available syntactic foams.

A further aspect of the present invention provides using an expandable epoxy foam as the structural filler in the buoyancy module shown in FIG. 1. The epoxy foam is available commercially in component form to produce foams of a variety of densities. The components of the foam are applied to the annular cavity, for example by pouring or injection. Once mixed within the cavity, the components react to form the foam. The reaction includes the effect of foaming the components to completely fill the cavity, providing a plurality of structural bridges extending between the inner and outer shell. The foams may be employed in a range of densities, typically from 100 to 800 kg/m³, more preferably from 150 to 600 kg/m³. The components for preparing the foam are available commercially, for example ex Sicomin Composites UK. Suitable foam products include PB150, PB250, PB400 and PB600, the number in the product designation indicating the density of the finished foam.

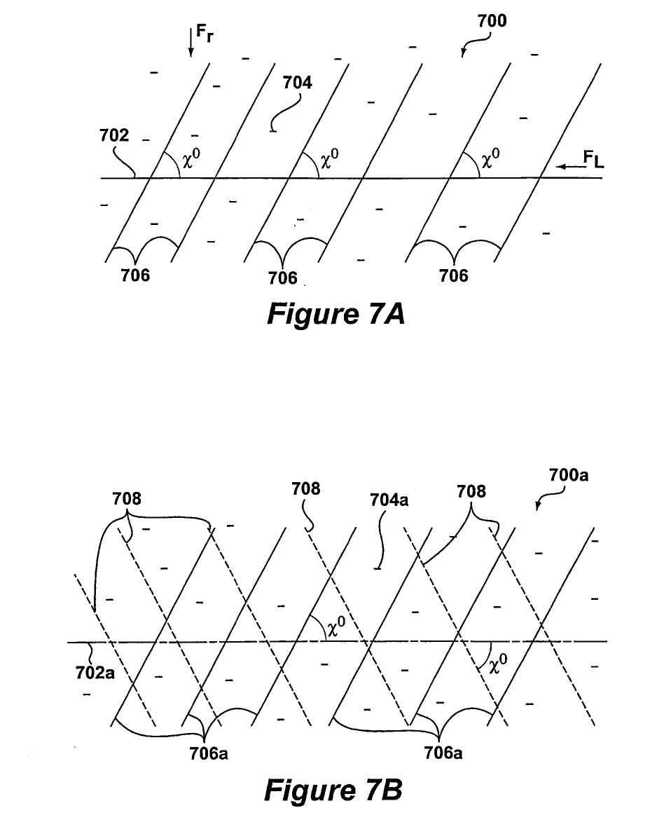

FIG. 5 shows a buoyancy module according to the present invention comprising a filler according to a further embodiment of the present invention. Components of the module of FIG. 5 identical to the module of FIG. 2 are indicated using the same reference numerals. The filler 500 employed in the module 2 of FIG. 5 is a substantially void-free filler consisting essentially of a continuous solid phase. The solid phase filler 500 provides a continuous structural bridge for transferring stresses between the inner shell 4 and the outer shell 6. The filler 500 is preferably a polymeric material, with resins being especially preferred. An example of a preferred material is polyester resin, with suitable resins being available commercially (for example Bi-Resin G48 and G55, available ex Hexcel). Further examples of suitable polymeric fillers include epoxy resins.

Resins generally require curing before becoming solid. The curing of a resin, such as a polyester resin, is an exothermic process. Depending upon the material of construction of the inner and/or outer shells 4, 6, the peak curing temperature of the resin may exceed the tolerance of the shells to heat. In such cases, it is advantageous to reduce the peak curing temperature of the resin by incorporating in the resin precursor a solid filler. Suitable solid fillers include chemically inert materials, such as calcium carbonate, available commercially as various grades of finely powdered chalk. Alternative solid fillers include fly-ash type materials (for example Fillite™).

The solid filler is included in an amount sufficient to reduce the peak curing temperature of the resin to below the lower of the maximum exposure temperature of the inner and outer shell. The solid filler may be present in an amount of from 10 to 70% by weight of the entire filler 500, more preferably from 20 to 60% by weight, especially from 30 to 50% by weight of the entire filler composition.

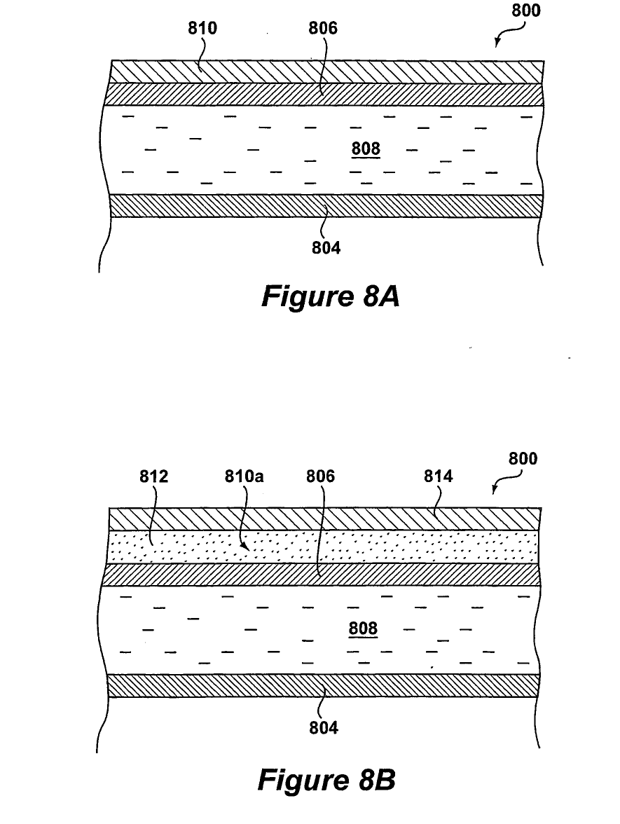

Referring to FIG. 6, a series of cross-sectional views of a module of the general design of FIG. 1 are shown, illustrating alternative designs of bulkheads. As indicated hereinbefore and as shown in FIG. 1, the module 2 may comprise one or more bulkheads 44 extending within the central buoyancy cavity 8. The bulkheads are employed within the buoyancy cavity 8 of the module and provide increased stiffness for the module structure. A bulkhead of plain design with a given thickness throughout may be employed. However, the presence of such a bulkhead may give rise to stress concentrations within the structure at the junction of the bulkhead with the inner shell, resulting from differential stiffness between the bulkhead and the inner and outer shells. Alternative designs for compliant bulkheads are provided, in order to reduce or eliminate the aforementioned differential stiffness.

FIG. 6a shows a bulkhead 600a of a first design. The bulkhead 600a has a region 602 of reduced thickness in its center. The thickness of the bulkhead 600a in region 602 is selected so as to reduce the differential stiffness to the desired level. FIG. 6b shows a bulkhead 600b of a second design. The bulkhead 600b is provided with a plurality of openings 604, the size, shape and number of which are selected to reduce the differential stiffness of the bulkhead 600b and the inner and outer shells to the required level. The openings 604 are shown in FIG. 6b as being substantially triangular. However, it will be understood that other shapes of opening can also be employed.

The module may employ one or more bulkheads. If a plurality of bulkheads are employed, they may be of the same design or of different designs.

The bulkheads may be prepared from the same materials as the inner shell and outer shell. Alternatively, the bulkhead may be formed from a different material to that of the inner and/or outer shell. The selection of the material of construction of the bulkhead will also depend the degree of compliance required of the bulkhead and the other features of the bulkhead design, such as the size and shape of any openings present. Suitable materials for construction of the bulkheads include metals, such as aluminium, alloys and steel, and polymers, such as polyolefins and polyesters.

As noted, the inner and outer shell may be formed from a variety of materials, with the inner and outer shells being of the same or dissimilar constructions. As noted above, one preferred material of construction for the inner and/or the outer shell of the module is a fibre-reinforced polymer. A further aspect of the present invention resides in the orientation of the fibres within the respective shell. It is possible to orient the fibres within the shell or shells to be either parallel to or circumferential to the central longitudinal axis of the buoyancy module. Such constructions will be suitable for use in shallow to medium depth applications. However, it has been found that an alternative orientation of the fibres is required if the module is to be successfully deployed at high depths, such as 5,000 feet or greater. As noted hereinbefore, the hydrostatic pressure acting upon the outer surface of the module gives rise to compressive forces and stresses acting radially inwards of the module. In addition, the hydrostatic pressure acting on the ends of the module gives rise to compressive forces acting longitudinally inwards of the module. It is an aspect of the present invention to provide a buoyancy unit in which the orientation of the fibres in the fibre-reinforced material of the inner and/or the outer shell are oriented to provide the shell with the sufficient strength to resist both the radial and longitudinal compressive forces encountered at depths.

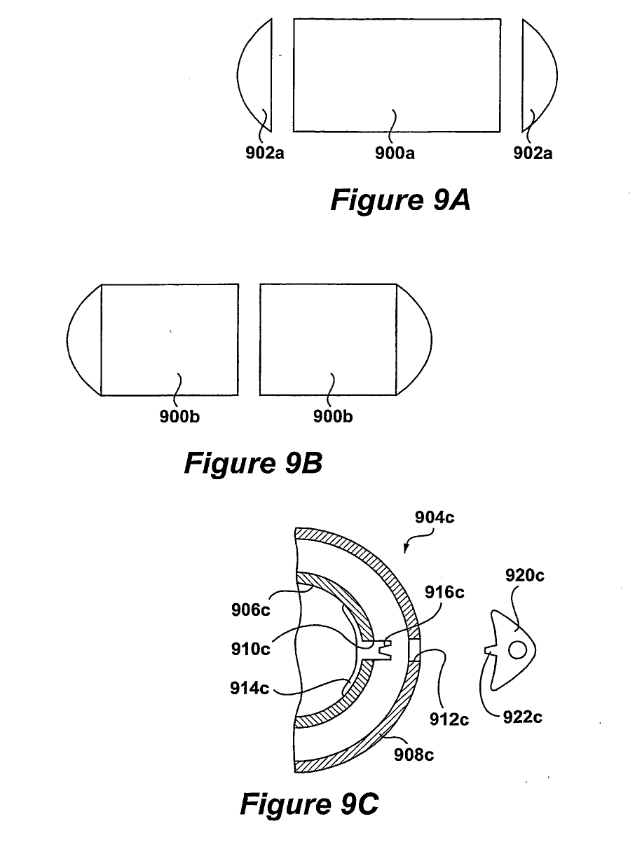

Referring to FIG. 7a, there is shown a schematic representation of a portion of a shell of a buoyancy module. The shell, generally represented as 700, may be the inner shell or the outer shell of a module of the general design shown in FIG. 1. The module has a central longitudinal axis 702. The shell comprises a fibre-reinforced matrix 704, in which a polymer matrix is provided with fibres 706 extending around the axis 702. The reference numerals 706 in FIG. 7a may refer to portions of a single fibre, or may refer to a plurality of different fibres. Preferably, the matrix 704 is reinforced by a plurality of fibres 706. Each fibre 706 extends at an angle x° to the longitudinal axis 702. The angle x° may be the same for each fibre or fibre portion, as shown in FIG. 7a. The angle x° is selected in order to provide the shell with resistance to compressive forces Fᵣ in the radial direction, provided by the resolved circumferential component of the resistance of the fibre to stress, and the necessary resistance to compressive forces F₁ in the longitudinal forces, provided by the resolved longitudinal component of the resistance of the fibre to stress.

The shell 700 may be formed of a single layer of the matrix 704. The matrix 704 may have fibres extending at just one angle x° to the longitudinal axis. In such a case, The angle x° for each fibre is in the range of from 25° to 85°, more preferably from 35° to 65°, with angles of from 45° to 60° being preferred. An angle of 55° provides a good combination to both radial forces Fᵣ and longitudinal forces F₁.

The matrix 704 may comprise a first group of fibres extending at a first angle x° to the longitudinal axis, and a second group of fibres extending at a second angle x° to the axis. In such cases, it is possible to employ the first group of fibres to provide the necessary resistance to radial compressive forces and the second group of fibres to provide the necessary resistance to longitudinal compressive forces. In such a case, the first group of fibres will extend at an angle x° greater than 55°, up to 90° to the longitudinal axis 702. The second group of fibres will extend at an angle x° less than 55°. For ease of construction, it is preferred that the second group of fibres extends at an angle greater than about 25° to the longitudinal axis 702. A most suitable orientation of the fibres is to have a first group extending at an angle of 75° to the axis 702 and the second group extending at an angle of 35° to the axis 702.

The fibres may be wound in combinations of more than two angles to the axis 702. For example, fibres may be wound in a combination of angles of +/−18°, +/−55° and +/−85° to the axis 702. Further combinations of angles will also be readily apparent.

In an alternative embodiment, the shell 700 comprises two layers of matrix 704, with the fibres in the first layer extending as described above for the first group of fibres and the fibres in the second layer extending as described above for the second group. For modules for deployment at great depths, the shell 700 may comprise a plurality of layers, with alternating first and second layers.

Referring to FIG. 7b, there is shown a schematic representation of a portion of a shell of a buoyancy module having an alternative fibre orientation. In the embodiment of FIG. 7b, a shell 700a has a central longitudinal axis 702a and is formed from a fibre-reinforced matrix 704a. The matrix 704a has first fibres 706a extending in a first general orientation around the axis 702a as described hereinbefore with reference to FIG. 7a. The embodiment of FIG. 7b has second fibres 708 shown as broken lines. The second fibres 708 extend in the opposing direction around the axis 702a, that is at an angle of −x° to the longitudinal axis. In other words, the first fibres 706a extend at an angle x° to the axis 702a and the second fibres 708 extend at an angle of 360-x° to the axis. The principles for selection of the angles for the fibres 706 in FIG. 7a set out above also apply to the selection of the angles of the second fibres 708 in FIG. 7b. Thus, the angle x° may be the same for all second fibres 708 or may differ, as described hereinbefore. Preferably, the shell 700a has first fibres extending at one or more angles x° and second fibres extending at one or more corresponding angles −x°.

The matrix 704a may consist of a single layer, having first and second fibres extending as described. Alternatively, the first fibres may be present in a first matrix layer and the second fibres in a second matrix layer. A plurality of layers may be provided with first and second fibres extending in separate layers.

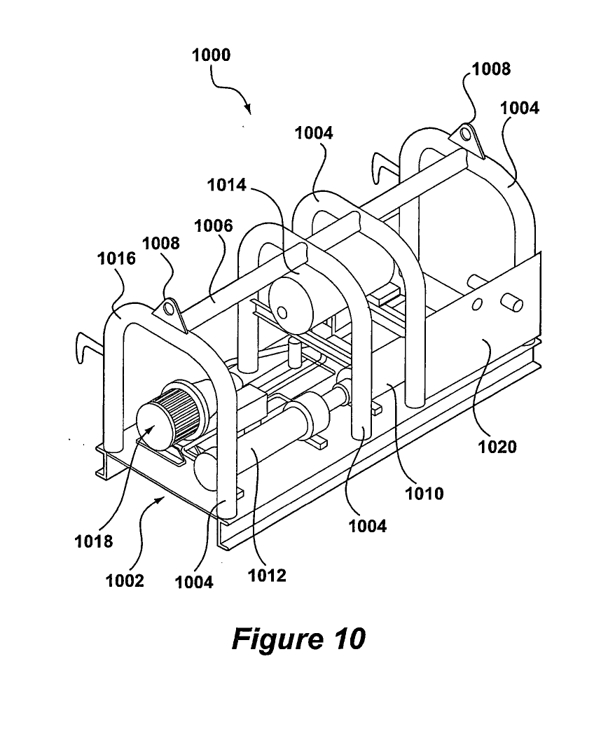

As shown in FIG. 1, the module of the present invention may consist of an inner shell, an outer shell and a structural filler disposed therebetween. As modules may be subject to rough treatment, including abrasions and impacts, during transportation, deployment and recovery, it is preferred to provide the outer shell with some protection, in order to prevent it being damaged and weakened. A preferred manner for protection is to provide a protective layer over the surface of the outer shell. FIG. 8a shows a first embodiment of a module with a protective layer.

Referring to FIG. 8a, a portion of the module 800 is shown in cross-section, showing the inner shell 804 and an outer shell 806. A structural filler 808 is disposed between the inner and outer shells 804, 806. The structural filler 808 may be any of the fillers hereinbefore described. To protect the outer shell 806, a rigid protective layer 810 is provided, covering the entire outer surface of the outer shell. The protective layer 810 of the embodiment shown in FIG. 8a consists of a layer of resistant, rigid material, such as a metal, for example steel, aluminium or an alloy, or a polymeric material, such as fibre-reinforced plastic. The protective layer 810 may consist of a single layer of the aforementioned materials, as shown in FIG. 8a. Alternatively, the protective layer 810 may be made up of two or more layers, applied successively to the outer surface of the module 800. Fibre-reinforced plastic materials are preferred materials for preparing the protective layer, as they may be applied by winding the fibres around the outer shell to build up a protective layer of the required thickness. As the protective layer 810 does not contribute to the hydrostatic load-bearing capacity of the module, the orientation of the fibres in the protective layer is not critical. Accordingly, the fibres may be oriented so as to provide the most convenient method of application of the protective layer.

An alternative embodiment of the protective layer is shown in FIG. 8b. Referring to FIG. 8b, a buoyancy module 800 is shown, having inner and outer shells 804 and 806, between which is disposed a filler 808. The filler may be any of the structural fillers hereinbefore described. The protective layer, generally indicated in FIG. 8b as 810a, comprises a shock or energy absorbing layer 812 disposed adjacent the outer surface of the outer shell 806. The energy absorbing layer 812 consists of a layer of material capable of absorbing the energy of an impact, while transferring little or no impact energy to the outer shell 806. The energy absorbing layer 812 is formed from a suitable energy absorbing material, such as a honeycomb or foam. The material is selected so as to deform under an impact to the module, thereby absorbing the energy of the impact. A most suitable energy absorbing material is syntactic foam, available commercially. The outer surface of the energy absorbing later 812 is covered in a rigid layer 814. The rigid layer 814 is formed as hereinbefore described with reference to the rigid protective layer of the embodiment shown in FIG. 8a.

The protective layer surrounding the outer shell of the module may be regarded as being a sacrificial layer, that is a layer which may be damaged, without compromising the overall integrity of the module. The protective layer, whether in the form of a single rigid layer or in the form comprising an energy absorbing layer with a rigid coating, is of sufficient thickness so as to deform and absorb impacts encountered during the normal transport and deployment of the module.

As noted above, one or preferably both of the inner and outer shells of the buoyancy module are formed from fibre-reinforced plastic materials. In a further aspect, the present invention provides a series of most advantageous methods for preparing a buoyancy module. In a first embodiment, the method comprises forming an inner shell. The inner shell may be prepared by winding plastic-impregnated fibres around a mandrel in known manner.

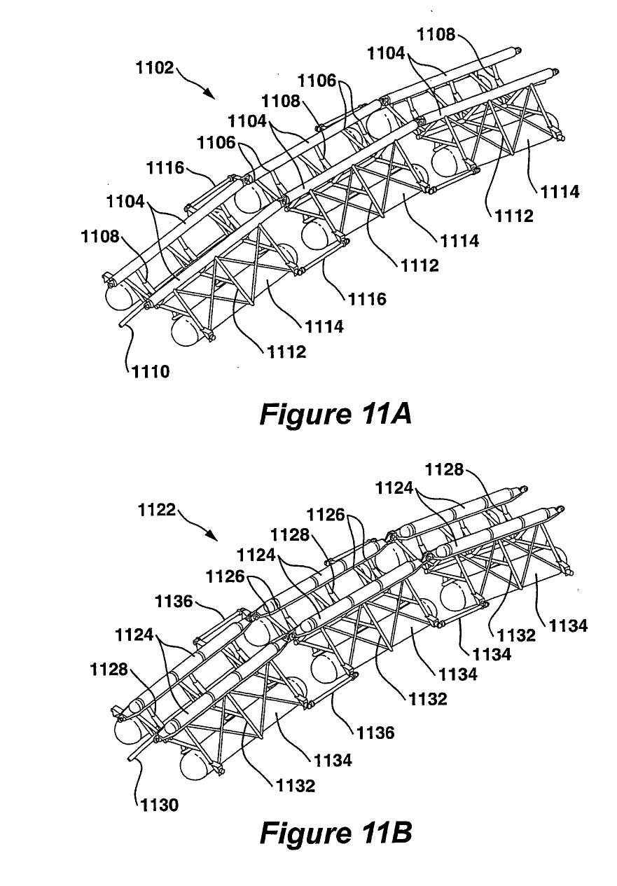

FIG. 9a shows an inner housing 900a and two domed inner housing ends 902a to be attached to respective ends of the inner housing. The inner housing is formed by winding impregnated fibres onto a mandrel to provide the requisite number of layers and shell thickness. Thereafter, the two housing ends 902a are attached to the inner housing 900a using a suitable adhesive. An alternative scheme is illustrated in FIG. 9b. In this alternative method, a combined inner housing and end assembly 900b is prepared by winding impregnated fibres onto a suitably shaped mandrel in known manner. Once the mandrel is removed, a housing end (as shown in FIG. 9a) may be attached to the open end of the housing 900b. Preferably, two of the combined inner housing and end assemblies 900b may be attached at their open ends to form a complete inner shell.

One or more bulkheads are installed in the inner housing before the inner shell is completed. The bulkheads may be installed by bonding to the inner shell using suitable high strength adhesives. Alternatively, the bulkheads may be secured by means of clamps or other mechanical fasteners, such as bolts.

Once the inner shell is complete, the structural filler is applied to the outer surface. The outer surface of the filler is finished, for example by machining, if necessary in order to prepare the surface. Thereafter, the outer shell is applied to the outer surface of the filler by winding impregnated fibres over the filler to form the requisite number of layers and shell thickness. The protective layer, if present, is thereafter applied.

In an alternative embodiment, an inner shell is prepared as hereinbefore described and as illustrated in either FIG. 9a or 9b. An outer shell of appropriate size is formed using the same known method using a mandrel. The outer shell is left open at either one or both ends, that is has the form of the housing 900a of FIG. 9a or the combined housing and end assembly 900b of FIG. 9b. The completed inner housing is inserted into the open end of the outer housing or outer housing portion, after which the cavity between the inner and outer housings is filled with the structural filler.

In a third embodiment, the inner and outer shells are formed as described above. The structural filler is applied to the outer surface of the inner shell and finished to the correct dimensions, for example by machining. The outer shell is heated to cause it to expand. The temperature to which the outer shell is heated will depend upon its material and the relative dimensions of the outer shell and the inner shell and filler. Once the outer shell is heated and expanded, the inner shell and filler are inserted into the outer shell, which is then allowed to cool. The contraction of the outer shell upon cooling generates an interference fit between the outer shell and the filler. An adhesive may also be employed to further strengthen the bond between the outer shell and the filler. The outer shell is then completed by the application of a second housing end or outer housing and end assembly to the exposed portion of the inner shell and filler.

Depending upon the method of construction, it may not be possible to completely fill the cavity between the inner shell and the outer shell at the module ends. In such a case, it is preferred to take additional steps to ensure that this portion of the cavity is filled with a filler, such as to provide a complete structural link between the inner shell and the outer shell throughout the entire module. The preparation of a domed end, either as a separate housing end (for example the housing end 902a of FIG. 9a) or as part of a combined housing and end assembly (for example the combined housing and end assembly 900b) requires that a hole be formed in the end, in order to support the mandrel about which the shell portion is being formed. The hole in the domed end of the inner shell is plugged, in order to ensure that the buoyancy cavity is fluid-tight. It is convenient to use the hole in the domed end of the outer shell to gain access to the cavity between the inner and outer shells, and fill the empty portion of the cavity with a suitable structural filler. The filler applied in this manner may be a foam, such as a syntactic foam, or a solid, void-free filler, such as a plastic or resin.

A most convenient arrangement for employing and sealing the holes in the dome ends is shown in FIG. 9c. FIG. 9c shows a cross-sectional view of the end of a module of the general design of FIG. 1. A dome-shaped housing end 904c has an inner housing end 906c and an outer housing end 908c. The inner housing end 906c has a hole 910c. A similar hole 912c is present in the outer housing end 908c. A backplate 914c, typically of steel, is mounted on the inner surface of the inner housing end 906c and extends around the hole 910c. The backplate 914c has a spigot 916c arranged to extend through the hole 910c in the inner housing 906c into the cavity between the inner housing end 906c and the outer housing end 908c. The spigot 916c has a blind central longitudinal bore therethrough and a thread formed on its inner surface. The backplate 914c and the spigot 916c are sealed to the inner housing end 906c, such that the hole 910c in the inner housing 906c is fluid-tight.

With the backplate 914c and the spigot 916c in place, a filler may be introduced into the cavity between the inner housing end 906c and the outer housing end 908c through the hole 912c in the outer housing end 908c. A pad eye 920c is provided, having a spigot 922c with a thread formed on its outer surface. Once the filler is in place in the cavity between the inner and outer housing ends 906c, 908c, the pad eye is secured to the outer surface of the outer housing end 908c, with the pad eye spigot 922c engaging with the spigot 916c extending from the backplate 914c. The pad eye 920c and spigot 922c are sealed to the outer housing end 908c such that it is a fluid-tight enclosure.

The buoyancy module of the present invention is deployed at underwater locations. It is a significant advantage of the module of the present invention that it is able to withstand the hydrostatic pressure present at great depths. The module may be attached to equipment and structures at the surface, before they are submerged. Alternatively, the module may be attached to the equipment or structures at an underwater location, be it the site of final deployment or a location intermediate between the surface and the site of final deployment. In either case, it will typically be necessary to ballast the module, in order to reduce its buoyancy, to assist with the deployment procedures. The fact that the module of the present invention can be ballasted in this way represents a significant advantage over the buoyancy units of the prior art, which generally have a fixed buoyancy, making it difficult to submerge them for movement underwater to a final location.

The modules of the present invention are ballasted by filling the buoyancy cavity within the inner shell with a suitable fluid. This is most conveniently water. The module is provided with an inlet to the buoyancy cavity, through which the ballast may be supplied. Typically, the module will be ballasted to provide a neutral buoyancy during the deployment procedures.

Once deployed, the ballast is removed from the buoyancy cavity of the module, returning the module to its buoyant state. This may be done in a conventional manner by forcing the ballast out of the module using a compressed gas, such as compressed air. This has serious disadvantages. First, as noted above, it is necessary to provide the compressed gas at a sufficient pressure to overcome the hydrostatic pressure at the deployment depth. Second, it is necessary to provide the module with two inlets, one for removing the ballast and one for the compressed driving gas. According to the present invention a method of deballasting a module is provided, whereby the ballast is withdrawn from the module.

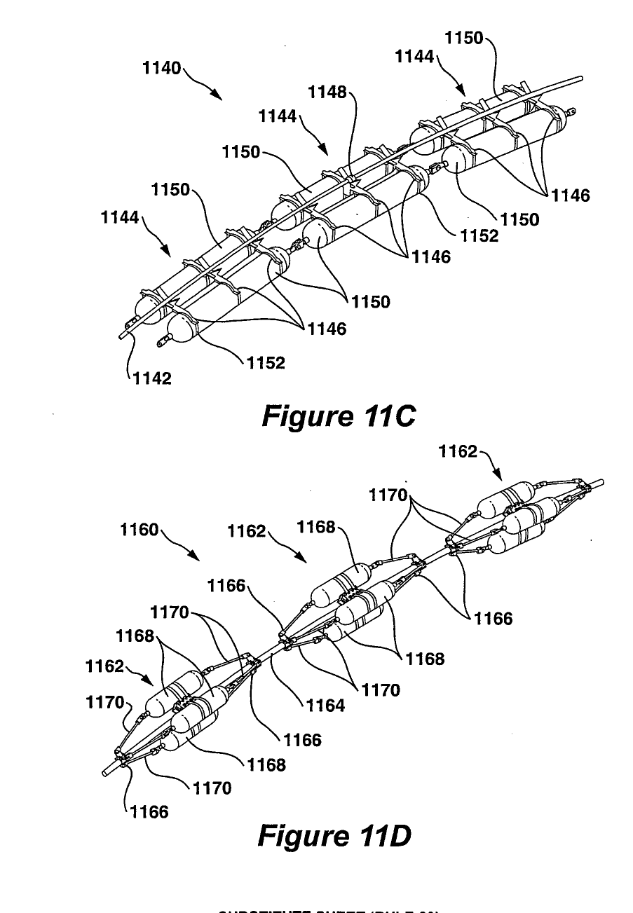

Referring to FIG. 10, there is shown a perspective view of a deballasting apparatus according to the present invention. The deballasting apparatus, generally indicated as 1000, comprises a generally rectangular base 1002. Hooped supporting members 1004 extend from the rectangular base 1002, joined at their top by a supporting beam 1006. Brackets 1008 are provided on each of the two end most hooped supporting members 1004, each bracket having a hole therethrough. The brackets 1008 allow the apparatus to be lifted, for example by a crane or derrick.

The deballasting apparatus 1000 comprises a deballasting cylinder assembly 1010, having a cylinder, within which a piston moves in a longitudinal direction. The cylinder assembly 1010 has a fluid inlet for connection to the buoyancy module and a fluid outlet. In cases in which the ballast to be withdrawn from the module is water, the fluid outlet may open into the environment.

The piston of the deballasting cylinder assembly 1010 is moved by means of a hydraulic cylinder 1012, which is fed hydraulic fluid from a hydraulic fluid reservoir 1014 by a hydraulic fluid pump 1016. Drive for the hydraulic fluid pump 1016 is provided by an electric motor 1018. The deballasting apparatus may be operated remotely from a vessel or platform on the surface, which may be connected to the apparatus by means of a cable. However, the embodiment shown in FIG. 10 comprises a tie-in interface 1020 for a ROV, by which means the apparatus is operated and controlled.

In use, the deballasting apparatus 1000 is deployed at an underwater location. Preferably this location is close to or adjacent the module from which the ballast is to be removed. For modules that are being deployed close to the surface, the deballasting apparatus may be situated on the surface vessel or platform. To deballast a buoyancy module, the fluid inlet of the deballasting cylinder assembly 1010 is connected to the fluid inlet of the module, typically be means of an ROV. The hydraulic cylinder 1012 is operated by being supplied with hydraulic fluid by the pump 1016, which in turn reciprocates the piston within the cylinder of the deballasting cylinder assembly 1010. Non-return valves ensure that ballast is withdrawn from the module into the cylinder through the fluid inlet and expelled through the fluid outlet.

In a final aspect, the present invention provides an integrity monitoring system for a buoyancy module, such as hereinbefore described. As the effectiveness of the module in providing buoyancy to underwater equipment and structures is dependent upon the integrity of the shell of the module, it is advantageous to monitor the integrity of the module. The monitoring system may comprise one or more gyroscopes for detecting and quantifying motion of the module, in order to identify whether the module has been subjected to any impacts or accidental loadings. This information serves to identify a module which should be inspected for damage prior to deployment.

An alternative integrity monitoring system employs one or more optical fibres incorporated into the shells of the module during fabrication. The methods of fabrication described hereinbefore and employing winding impregnated fibres around a mandrel or substrate lend themselves very well to the incorporation of optical fibres into the module structure. The optical fibres are employed to gain information concerning the integrity of the module. The equipment for gathering this information may be mounted within the shell of the module, or may be attached to the module remotely, for example by means of a ROV. The optical fibre system can be employed to provide an active monitoring system which may be interrogated by a ROV while the module is in place at the underwater location. It is preferable that the strain of the module is monitored at least immediately following its fabrication and prior to its deployment.

A preferred integrity monitoring system comprises both one or more gyroscopes and an optical fibre system.

The apparatus of the present invention may be employed at any underwater location where buoyancy is required. Examples include mid water arch buoyancy for risers, temporary buoyancy for assistance in the installation of other equipment and structures, distributed buoyancy for risers, and shallow water, large volume top tank buoyancy for vertical self-standing risers. Examples of specific underwater structures that may employ buoyancy modules as hereinbefore described will now be described in detail.

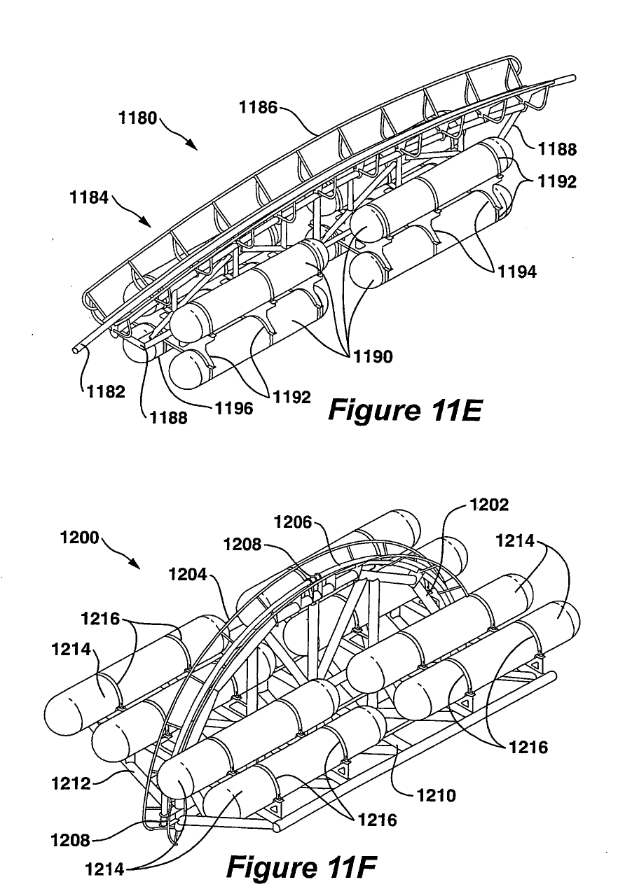

Referring to FIG. 11a, there is shown a first design of articulated arch for supporting pipes above the seabed at underwater locations. The articulated arch, generally indicated as 1102, comprises a plurality of elongate tubular steel support members 1104 connected together at their respective ends by hinge joints 1106. The support members 1104 are arranged side by side in pairs, with the support members of each pair being connected by a rigid triangular framework of tubes 1108. The tubular framework 1108 accommodates a portion of an underwater pipeline 1110 which is being supported by the arch at a distance above the sea bed. A rigid triangular support structure 1112 extends from each support member 1104, to which is attached a buoyancy module 1114. The buoyancy modules 1114 preferably comprise one or more embodiments of the present invention, as hereinbefore described. Adjacent buoyancy modules 1114 are connected by tie bars 1116.

Referring to FIG. 11b, there is shown a second design of articulated arch for supporting pipes above the seabed at underwater locations. The articulated arch, generally indicated as 1122, comprises a plurality of elongate buoyancy modules 1124 connected together at their respective ends by hinge joints 1126. The buoyancy modules 1124 act, as their primary function, as structural members. However, they perform a secondary function of providing a measure of buoyancy to the arch structure. The buoyancy modules 1124 preferably comprise one or more embodiments of the present invention, as hereinbefore described. The buoyancy modules 1124 are arranged side by side in pairs, with the module of each pair being connected by a rigid triangular framework of tubes 1128. The tubular framework 1128 accommodates a portion of an underwater pipeline 1130 which is being supported by the arch at a distance above the sea bed. A rigid triangular support structure 1132 extends from each module 1124, to which is attached a main buoyancy module 1134. The main buoyancy modules 1134 preferably comprise one or more embodiments of the present invention, as hereinbefore described. Adjacent buoyancy modules 1134 are connected by tie bars 1136.

Referring now to FIG. 11c, there is shown an articulated truss arch design. The truss arch, generally indicated as 1140, is supporting an underwater pipeline 1142. The truss arch comprises a series of horizontal support structures 1144, each comprising three support bars 1146. The arrangement shown in FIG. 11c has three such support structures 1144, with the center structure having its central support bar 1146 attached to the pipeline by a clamp 1148. A pair of buoyancy modules 1150 are secured to the support bars 1146 of each support structure 1144 by means of straps 1152. Adjacent buoyancy modules 1150 are attached at their respective ends by hinge joints 1154. The truss arch 1140 will comprise sufficient support structures 1144 and buoyancy modules 1150 to provide the desired level of floatation for the pipe or pipes being suspended. The buoyancy modules 1150 preferably comprise one or more embodiments of the present invention, as hereinbefore described.

A distributed buoyancy module arch is shown in FIG. 11d. The arch, generally indicated as 1160, comprises a plurality of buoyancy assemblies, each indicated generally as 1162, supporting a pipeline 1164. Each buoyancy assembly 1162 comprises two clamps 1166 secured to the pipeline 1164, one clamp disposed at each end of the assembly. Buoyancy modules 1168 are attached to and extend between the clamps 1166 by retaining bars 1170. FIG. 11d shows each buoyancy assembly 1162 comprising three buoyancy modules 1168. However, fewer or more modules may be employed, as required. The number of buoyancy assemblies 1162 employed is determined by the buoyancy requirement of the pipeline. The buoyancy modules 1168 preferably comprise one or more embodiments of the present invention as hereinbefore described.

FIG. 11e shows a lay-over arch for supporting a pipeline. The lay-over arch, generally indicated as 1180, supports a pipeline 1182 at a distance above the sea bed. The pipeline 1182 rests in a tubular support assembly 1184 having an arcuate supporting cradle 1186. A tubular framework 1188 extends from the cradle 1186, to which is attached a plurality of buoyancy modules 1190 by means of horizontal support arms 1192 and straps 1194. The arch 1180 is tethered to the sea bed or an underwater structure (not shown) by means of lines (not shown for clarity) secured to brackets 1196 on the tubular framework 1188. The number of buoyancy modules 1190 employed will depend upon the buoyancy requirement for the arch. The buoyancy modules 1190 preferably comprise embodiments of the present invention as hereinbefore described.

FIG. 11f shows a tied-in arch for supporting an underwater pipeline. The tied-in arch, generally indicated as 1200, comprises a vertically extending tubular support structure 1202, supporting an arcuate cradle 1204. A pipeline 1206 is secured to the cradle 1204 by means of clamps 1208. A horizontally extending tubular support structure 1210 extends from either side of the support structure 1202, strengthened by a triangulation framework 1212. Buoyancy modules 1214 are secured to the horizontal support structure by straps 1216. The tied-in arch 1200 is tethered to the sea bed or other underwater structure (not shown) by lines (not shown) attached to the horizontal or vertical support structure. The number and design of the buoyancy modules 1214 is varied according to the floatation duty to be performed. Preferably, the buoyancy modules comprise one or more embodiments of the present invention, as hereinbefore described.

Embodiments of the present invention will be further described, by way of illustration only, by reference to the following examples.

### EXAMPLES

A series of buoyancy modules were prepared with structures and according to the procedures as described above.

The modules were assembled with both inner and outer shells prepared from carbon fibres (T700, ex Toray) and epoxy resin (Bakerlite L20). The modules of Examples 1 to 3 were prepared using the carbon fibres and epoxy resin in the form of pre-impregnated fibres in strips (pre-pregs). The remaining modules were prepared using fibres impregnated with resin at the time of fabricating the shells.

The modules were prepared having a nominal length of 800 mm. The modules were substantially cylindrical and had flat ends on both the inner and outer housings. The modules of Examples 1 to 4 and 6 to 9 were prepared using a one unit mandrel (nominal length 1000 mm), with one inner shell being formed per run on the mandrel. Example 5 was prepared using a two unit mandrel (nominal length 2000 mm), from which two inner shells could be cut. Generally, a greater similarity of shells is obtained when a plurality of shells are wound on a multi-unit mandrel at the same time, for example by winding a single tube and cutting the tube into a plurality of portions to form the inner shells.

A variety of fillers were employed. The honeycomb filler used in Examples 1 to 4 was a nylon honeycomb (Nomex, 48 kg/m³, approx 5 mm ( 3/16 in) cell size ex Hexcel). Example 5 employed an aluminium honeycomb (83 kg/m³, approx 6 mm cell size). Example 6 employed aluminium channel rings as the structural filler. Examples 7 and 8 were prepared using a solid polyester resin filler (Bi-Resin G48, ex Hexcel). Example 9 was prepared with an expandable epoxy foam filler (PB600, 600 kg/m³, ex Sicomin Composites UK).

A variety of lay angles were employed when winding the fibres, as indicated in Table 1, with the fibres being wound in each case in a plurality of layers, also as indicated.

The surface of the inner and outer shells was treated where indicated with peel-ply tape to draw out excess resin from the shell, in order to render the surface smooth and free of voids.

The details of the modules, their dimensions, configuration and manner of construction, are set out in Table 1 below.

TABLE 1

| | | | | | Wall | |
|---|---|---|---|---|---|---|
| | | Filler | | No. of | thickness | Mandrel |
| Example | Filler | Thickness | Lay Angle of | layers in | of Shell | ID |
| No. | Type* | (mm) | Fibres in Shell | Shell | (mm) | (mm) |
| 1 | HC | 15 | Inner: +/− 30° | Inner: 6 | Inner: 3.8 | Inner: 200 |
| | | | Outer: +/− 75° | Outer: 10 | Outer: 5.4 | |
| 2 | HC | 8 | Inner: +/− 25° | Inner: 4 | Inner: 2.6 | Inner: 200 |
| | | | Outer: +/− 75° | Outer: 10 | Outer: 5.4 | |
| 3 | HC | 15 | Inner: +/− 30° | Inner: 2 | Inner: 1.3 | Inner: 200 |
| | | | Outer: +/− 65° | Outer: 6 | Outer: 3.3 | |
| 4 | HC | 8 | Inner: +/− 85° | Inner: 12 | Inner: 3.6 | Inner: 194.2 |
| | | | and +/− 60° | Outer: 24 | Outer: 6.3 | |
| | | | Outer: +/− 85° | | | |
| | | | and +/− 70° | | | |
| 5 | HC | 15 | Inner: +/− 85° | Inner: 2 | Inner: 1.1 | Inner: 251.1 |
| | | | and +/− 30° | Outer: 6 | Outer: 3.2 | |
| | | | Outer: +/− 85° | | | |
| | | | and +/− 50° | | | |
| 6 | CHR | 15 | Inner: +/− 85° | Inner: 4 | Inner: 2.3 | Inner: 243 |
| | | | and +/− 15° | Outer: 4 | Outer: 2.3 | |
| | | | Outer: +/− 85° | | | |
| | | | and +/− 15° | | | |
| 7 | SP | 20 | Inner: +/− 85° | Inner: 8 | Inner: 4.42 | Inner: 201 |
| | | | and +/− 33° | Outer: 8 | Outer: 4.42 | Outer: 250 |
| | | | Outer: +/− 85° | | | |
| | | | and +/− 33° | | | |
| 8 | SP** | 20 | Inner: +/− 85° | Inner: 8 | Inner: 4.42 | Inner: 201 |
| | | | and +/− 33° | Outer: 8 | Outer: 4.42 | Outer: 250 |
| | | | Outer: +/− 85° | | | |
| | | | and +/− 33° | | | |
| 9 | EF** | 20 | Inner: +/− 85° | Inner: 8 | Inner: 4.52 | Inner: 201 |
| | | | and +/− 25° | Outer: 10 | Outer: 5.40 | Outer: 250 |
| | | | Outer: +/− 85° | | | |
| | | | and +/− 35° | | | |

*HC = honeycomb; CHR = channel ring; SP = solid polymer; EF = expanded foam
**Peel-ply applied to surfaces of both inner and outer shells

Each of the buoyancy modules of Examples 1 to 10 was tested for resistance to external pressure in a hyperbaric chamber.

Each module was placed in the hyperbaric chamber and was then subjected to increasing water pressure, to simulate the hydrostatic pressure of underwater locations. The pressurization of the chamber was commenced incrementally from ambient to 50% design pressure. At each increment of pressurization the pressure was held for a nominal time to allow potential time dependent responses of the module to occur and be monitored.

Successful completion of pressurization to the 50% design pressure was followed by incremental pressurization of the chamber until failure of the module occurred. A failure of the module is herein defined as either the catastrophic failure of the module through collapse, or compromise of the structural integrity of the module leading to a loss of external pressure bearing capacity.

Sensors were employed in the hyperbaric chamber and the module to monitor the hydrostatic pressure both in the hyperbaric test chamber and the internal volume/pressure of the central air filled void, and the strain on the surfaces of both the inner and outer shells of the module.

The monitoring of each module was conducted according to the following procedure:
1. Logging of sensor output readings for initial conditions taken for 15 seconds.
2. Increase hydrostatic pressure to 12.5% of design pressure.
3. At 12.5% of design pressure hold pressure.
   a. Upon reaching desired pressure a recording of the sensor output was taken for 15 seconds. Volumetric changes of the inner shell were recorded using a manometer.
   b. After 4 minutes at pressure a second recording of the sensor output was taken for 15 seconds. Volumetric changes of the inner shell were recorded using a manometer.
   c. After 8 minutes at pressure a second recording of the sensor output was taken for 15 seconds. Volumetric changes of the inner shell were recorded using a manometer.
   d. After 12 minutes at pressure a second recording of the sensor output was taken for 15 seconds. Volumetric changes of the inner shell were recorded using a manometer.
4. Pressure was increased by 5% of design pressure and the procedure outlined in (3) repeated until 50% of the design pressure was achieved.
5. The procedure of (3) was repeated at 2.5% increments of design pressure until failure of the modules occurred.

The results of the hyperbaric tests are set out in Table 2 below, with values for the FVF, circumferential modulus, axial modulus, circumferential strength and axial strength given for both inner and outer shells (inner/outer).

The Fibre Volume Fraction digestion (FVF) of the shells was determined using acid digestion, to determine the carbon fibre content of the carbon fibre/epoxy matrix. The results are indicated in Table 2 for both the inner and outer shells (inner/outer) of each module tested.

Failure pressure is indicated for the module as a whole. Each experiment was repeated, without instrumentation in the module. The results for the failure pressure in both runs is given (non-instrumented/instrumented).

| | | Circumferential | Axial | Circumferential | Axial | Failure |
|---|---|---|---|---|---|---|
| | FVF | Modulus | Modulus | Strength | Strength | Pressure |
| Example | (Digestion) | (GPa) | (Gpa) | (MPa) | (MPa) | (bar) |
| 1 | 59/66 | 10/123 | 14/7 | 216/106 | 279/88 | 67/6 [symbol] |
| 2 | 50/65 | 12/97 | 23/8 | 162/325 | 249/94 | 71/7 [symbol] |
| 3 | 50/59 | 11/43 | 42/7 | 173/328 | 328/111 | 36/3 [symbol] |
| 4 | 57/60 | 72/66 | 8/6 | 283/166 | 40/80 | 100/1 [symbol] |
| 5 | 55/57 | 56*/71 | 37/7 | 335/254 | 266/140 | 28/3 [symbol] |
| 6 | 56/55 | 42/28 | 54/49 | 198/171 | 330/268 | 64/6 [symbol] |
| 7 | 65/65 | 57/63 | 29/27 | 161/261 | 174/136 | 275/1 [symbol] |
| 8 | 61/65 | 66/60 | 24/19 | 190/121 | 180/159 | 115/1 [symbol] |
| 9 | 58/57 | 73/59 | 24/14 | 148/168 | 207/159 | 229/2 [symbol] |

*Tensile modulus given

The results set out in Table 2 indicate that embodiments of the present invention are capable of resisting hydrostatic pressure at depths of almost 3,000 metres (about 9,000 feet).

As described and exemplified above, the apparatus of the present invention finds particular use as a means of providing buoyancy at underwater locations. However, as noted, the apparatus also finds use as an enclosure for housing pressure-sensitive equipment, particularly in underwater locations. The data set out above show that the apparatus is capable of housing and protecting pressure sensitive equipment to substantial depths.

The specific embodiments and examples of the present invention have been included for illustrative purposes only. Alternatives to the specific embodiments herein disclosed are also envisaged without departing from the principles of the present invention.

1. Apparatus for providing an enclosure in locations of elevated pressure, the apparatus comprising:
an inner housing comprising an inner housing body and two opposing inner housing ends;
an outer housing comprising an outer housing body and two opposing outer housing ends;
the inner housing being disposed fully within the outer housing, the inner and outer housings defining an annular cavity therebetween; and
a structural filler within the cavity extending between the outer housing and the inner housing, the structural filler comprising a plurality of spaced apart structural members for transferring stress between spaced apart regions of the inner surface of the outer housing to corresponding spaced apart regions of the outer surface of the inner housing, the structural members occupying less than 60% of the volume of the cavity occupied by the structural filler.

2. Apparatus according to claim 1, wherein the structural members occupy less than 50% of the volume of the cavity occupied by the structural filler.

3. Apparatus according to claim 2, wherein the structural members occupy less than 25% of the volume of the cavity occupied by the structural filler.

4. Apparatus according to claim 1, wherein the structural members extend circumferentially within the cavity.

5. Apparatus according to claim 1, wherein the structural members extend at an angle to the longitudinal axis of the apparatus.

6. Apparatus according to claim 5, wherein the structural members comprise a honeycomb material.

7. Apparatus according to claim 6, wherein the honeycomb is metal or a polymer.

8.-9. (canceled)

10. Apparatus according to claim 1, wherein the structural members are of an I-beam configuration or are tubular.

11. (canceled)

12. Apparatus according to claim 10, wherein the structural members extend helically around the longitudinal axis within the cavity.

13. (canceled)

14. Apparatus according to claim 12, wherein the structural members are tubular having a circular cross-section and contain a pressurized fluid in order to pre-stress the structural member to resist compressive hydrostatic forces.

15.-22. (canceled)

23. Apparatus according to claim 1, wherein at least one of the inner housing or the outer housing comprises a fibre-reinforced matrix comprising one or more fibres extending helically with respect to the longitudinal axis of the apparatus, each fibre extending at an angle of from 25° to 85° to the longitudinal axis of the apparatus.

24. (canceled)

25. Apparatus according to claim 23, wherein each fibre extends at an angle of from 35° to 65° to the longitudinal axis of the apparatus.

26. (canceled)

27. Apparatus according to claim 25, wherein the at least one of the inner housing or the outer housing comprises a plurality of layers of fibre-reinforced matrix, one of a pair of adjacent layers having one or more fibres extending at an angle of x° to the longitudinal axis and the second of the pair of adjacent layers having one or more fibres extending at an angle of 360-x° to the longitudinal axis.

28. Apparatus according to claim 27, wherein x is an angle in the range of from 45° to 65°.

29.-87. (canceled)

88. A method of deploying a buoyancy apparatus at an underwater location where buoyancy is required, which apparatus has a fluid-tight cavity capable of accommodating a liquid, the method comprising:
ballasting the apparatus by filling the fluid-cavity with a liquid to an extent necessary to provide the appropriate level of buoyancy;
positioning the apparatus at the said location; and
withdrawing the liquid from the fluid-tight cavity.

89. A method according to claim 88, wherein the liquid is withdrawn by means of a reciprocating piston moved within a cylinder.

90. A method according to claim 89, wherein the liquid is withdrawn by repeated operations of the reciprocating piston through a cycle comprising:
movement of the piston in a first direction to draw liquid from the fluid-tight cavity into the cylinder;
movement of the piston in a second direction, opposite the first, to eject liquid from the cylinder to a location other than the fluid-tight cavity.

91. (canceled)

92. A method according to claim 91, wherein the liquid is water and the water is ejected into the environment.

93.-102. (canceled)
